(19) United States
(12) Patent Application Publication
(10) Pub. No.: US 2007/0016653 A1
(43) Pub. Date: Jan. 18, 2007

(54) Event triggering over a network

(76) Inventors: Jan Larsen, Hudson, WI (US); Rick Mathewson, Hudson, WI (US)

Correspondence Address: FISH & RICHARDSON P.C., PO BOX 1022, MINNEAPOLIS, MN, 55440-1022, US

(21) Appl. No.: 11/481,148

(22) Filed: Jul. 5, 2006

Related U.S. Application Data
(60) Provisional application No. 60/698,783, filed on Jul. 13, 2005.

(51) Int. Cl. G06F 15/16

(52) U.S. Cl. 709/217

(57) ABSTRACT

Methods, and associated systems and apparatus, relate to controlling one or more target devices with a controller that has an event table that associates simple (non-command formatted) event identifiers with command-formatted commands that can be triggered by network messages containing one of the event identifiers. In some embodiments, event identifiers may be included in the payload of network messages generated in response to a hyperlink command. In an illustrative example, selecting a hyperlink in an application program may cause a simple event identifier, such as event “3”, to be sent in a network message to a controller. In response, the controller may perform operations to execute commands associated with event “3” in the event table. The operations may be performed in the controller and/or transmitted to the target device.

### CROSS-REFERENCE TO RELATED APPLICATIONS

This application claims priority to U.S. Provisional Application Ser. No. 60/698,783, titled “Event Triggering Over a Network” to Larsen, et al., filed on Jul. 13, 2005, the entire contents of which are incorporated herein by reference

### BACKGROUND

Networks can be used to connect electronic devices to provide for data communication. Information flows on a network may be uni-directional (e.g. satellite television broadcasts) or bi-directional (e.g., electronic mail).

One type of network is a local area network (LAN), which typically supports a limited number of users in a small geographic area. Another type of network is a wide area network (WAN), which may support a large number of users over a large geographic area. WANs can be used to connect local area networks together, so that users and computers in one location can communicate with users and computers in other locations. Many WANs are built for one particular organization and are private. Others, built by Internet service providers, may provide connections from an organization'LAN to the Internet, which is an example of a WAN.

The Internet is the publicly available worldwide system of interconnected computer networks that transmit data by packet switching over the Internet Protocol (IP). It is made up of thousands of other, smaller business, academic, and government networks that provide various information and services, such as by electronic mail, online chat, and on the graphical, interlinked World Wide Web.

The Internet is typically accessed using a web browser. A web browser (or Internet browser) is a software application that enables a user to display and interact with HTML (hypertext markup language) documents hosted by web servers or held in a file system. HTTP (hypertext transfer protocol) allows web browsers to submit information to web servers as well as fetch web pages from them. Pages are located by means of a URL (uniform resource locator), which is treated as an address, beginning with http: for HTTP access. Many browsers also support a variety of other URL types and their corresponding protocols, such as ftp: for FTP (file transfer protocol), gopher: for Gopher, and https: for HTTPS (an SSL encrypted version of HTTP).

The file format for a web page is usually HTML and is identified in the HTTP protocol using a MIME content type. Most browsers natively support a variety of formats in addition to HTML, such as the JPEG, PNG and GIF image formats, and can be extended to support more through the use of plug-ins. The combination of HTTP content type and URL protocol specification allows web page designers to embed images, animations, video, sound, and streaming media into a web page, or to make them accessible through the web page. Some web pages include one or more hyperlinks.

In a typical context, a hyperlink may serve as a reference in a hypertext document to another document or other resource. One hyperlink target may be associated with a URL on the World Wide Web. The URL may point to a document, e.g., a webpage, or other resource, or to a position in a webpage. In that context, it may be considered to be similar to a citation in literature. In combination with a data network and suitable access protocol, a hyperlink may be used to fetch the resource referenced by the hyperlink. In a typical scenario, a hyperlink may cause a resource from the target to be retrieved so that the resource may be saved, viewed, or displayed on the source. In some cases, the retrieved resource may be displayed as part of the referencing document.

### SUMMARY

Methods, and associated systems and apparatus, relate to controlling one or more target devices with a controller that has an event table that associates simple (non-command formatted) event identifiers with command-formatted commands that can be triggered by network messages containing one of the event identifiers. In some embodiments, event identifiers may be included in the payload of network messages generated in response to a hyperlink command. In an illustrative example, selecting a hyperlink in an application program may cause a simple event identifier, such as event “3”, to be sent in a network message to a controller. In response, the controller may perform operations to execute commands associated with event “3” in the event table. The operations may be performed in the controller and/or transmitted to the target device.

In some embodiments, network messages may be platform independent commands, such as http commands.

Other systems and associated methods relate to an I/O (input/output) server that can perform one or more predetermined actions in response to an event trigger that is mapped to the actions to be performed. An event database on an I/O server contains information that associates each of at least one event trigger with at least one predetermined output action. The I/O server may receive event trigger information via a network interface port, a communication port, or an interface coupled to hardware elements such as infrared (IR) receivers and switch contacts (e.g., relays). The I/O server may perform actions such as sending a message, operating a general purpose output, or communicating via IR. In some embodiments, the I/O server may be addressable on a network, such as the Internet. Using the network connection, multiple I/O servers can share messages.

Network messages may be sent in response to a trigger. Some network messages may be received as an event trigger by an I/O server. Network messages that are interpreted as an event trigger may be sent from one I/O server and addressed to one or more other I/O servers on the network.

Some embodiments may provide one or more advantages. For example, powerful controls for any number of devices may be developed without users having any detailed knowledge of device specific hardware commands. Simple event numbers or codes, such as “1” or “3,” may be translated into one or more complex device-specific commands to one or more controlled devices. Such event numbers or codes may be incorporated, for example, into hyperlinks embedded in application programs and/or as desktop shortcuts. As such, application program users may send event triggers seamlessly, without interrupting or leaving an application program. In addition, hyperlink event triggers may be substantially platform independent. Furthermore, changes to command-formatted commands resulting from hardware or software updates in the controlled devices may be accommodated without the need for the user to modify the event codes. Accordingly, powerful event controls may be developed and maintained with minimal time, training, and expense.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a network architecture including an input/output (I/O) control system with an I/O server.

FIG. 2 is a block diagram of an exemplary I/O server.

FIG. 3 is a data table in an event database stored in an I/O server.

FIG. 4 is a graphical user interface (GUI) display to enable a user to define network configuration settings for an I/O server.

FIG. 5 is a GUI display of a command line interface for an I/O server.

FIG. 6 is a GUI display of event configuration settings for an I/O server.

FIG. 7 is a user interface with embedded hyperlinks for triggering events.

FIG. 8 is a flow chart of exemplary operations that may be performed by an I/O server.

FIG. 9 is a flow chart of exemplary operations that may be performed when using a hyperlink to trigger an event.

FIG. 10 is a block diagram of a network architecture for an I/O control system containing an I/O router.

FIG. 11 is a block diagram of an I/O device with an embedded I/O server connected to a network.

FIG. 12 is a flow chart of exemplary operations that may be performed to send a hyperlink over a network to trigger an event.

FIG. 13 is a flow chart of exemplary operations that may be performed when a hyperlink is received.

Like reference numerals in the various drawings indicate like elements.

### DETAILED DESCRIPTION OF ILLUSTRATIVE EMBODIMENTS

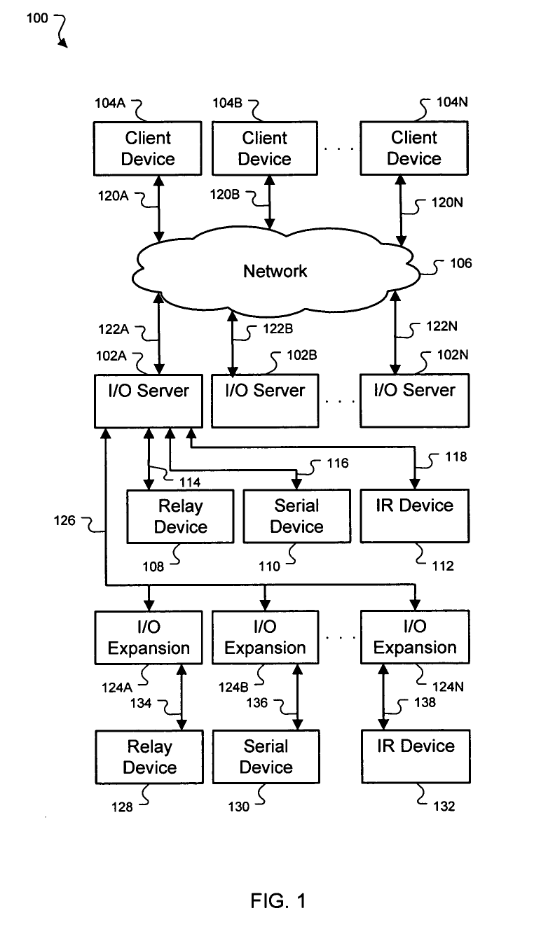

FIG. 1 shows one embodiment of a network architecture for an exemplary I/O control system 100. In this example, the I/O control system 100 includes I/O servers 102A-102N, each of which may communicate with one or more client devices 104A-104N via a network 106, such as the Internet. The I/O server 102A is connected to a number of I/O devices. In this example, the I/O server 102A is coupled to a relay device 108, a serial device 110, and an infrared (IR) device 112. The I/O server 102A may receive inputs, such as a relay state change from the relay device 108, a serial message from the serial device 110, and/or an IR signal from the IR device 112, as represented by arrows 114, 116, and 118 respectively. The I/O server 102A may also receive inputs from any or all of the client devices 104A-104N via the network 106, as represented by arrows 120A, 120B, and 120N. In addition, the I/O server 102A may communicate with the other I/O servers 102B-102N via the network 106, as represented by arrows 122B and 122N. In various embodiments, any or all of the functions and features described with reference to the I/O server 102A of this example may be similarly applied to each of the I/O servers 102B-102N, or any additional servers that may be included in the I/O control system 100.

An input received at an I/O server may trigger one or more associated outputs. Exemplary outputs may be in the form of relay state changes to relay devices, serial messages to serial devices, IR signals to IR devices, or parallel messages to parallel devices. In some embodiments, the I/O may also take the form of audible, optical (e.g., fiber optic), radio frequency (RF), electrical, or magnetic signals, or mechanical motion or vibration. The I/O servers 102A-102N may also send or receive messages via the network 106.

For example, the I/O server 102A may receive an input indicating a change of state of the relay device 108, such as may result from a switch being toggled from “off”to “on.” The I/O server 102A may be configured to associate such an event with one or more actions to be executed by the I/O server 102A. The actions to be executed may include, for example, sending a serial output to the serial device 110 and an IR output to the IR device 112. In one implementation, for example, the I/O server 102A may respond to the switch being set to the “on” position by sending (1) a serial command to a videocassette recorder (VCR), which in turn may, respectively, cause a cassette tape to start playing; and (2) an IR command to turn on a video display device coupled to the VCR.

In another example, a user may select a hyperlink embedded on a web page and displayed in a web browser at one of the client devices 104A-104N. In one example, a hyperlink may generate a predetermined action in response to a user input (e.g., clicking on a displayed object using a pointer). The user input and the generated action may occur within the same or different application programs, or on the same or different object or device. In a particular example, a hyperlink may trigger an action on the I/O server 102A. In a further example, the action performed by the I/O server 102A may include sending a message to the server 102B over an Ethernet connection. In this example, selecting a hyperlink on a client device may trigger communications between two or more I/O servers over a network.

In an alternative example, a network message, containing at least a header and a payload, may be used as a trigger. The header or the payload may contain parameters or other control information that, when interpreted by the I/O server, can trigger an action or sequence of actions. For example, a USB (universal serial bus) command may be used to trigger actions by embedding event identifier information in the payload portion of the message.

In embodiments, hyperlinks may provide a platform-independent solution that can be implemented on widely available operating systems that support hyperlinks and, in particular embodiments, on operating systems that support uniform resource locator (URL) hyperlinks. Moreover, various implementations may be developed without detailed platform-specific knowledge, and without complex software programming.

As will be described in detail below, the I/O server 102A may receive a request initiated by the selection of the hyperlink, and the hyperlink may contain an identifier (ID) for an event to be executed. The I/O server 102A determines which one or more events are to be executed based on the event ID contained in the hyperlink. Upon determining the events, the I/O server 102A may execute program instructions to execute any actions associated with each event, such as sending the serial command to the VCR to start playing the cassette tape and the IR command to turn on the video display device.

In addition to web pages, one or more hyperlinks may be contained in other application programs, such as a slide show presentation, a word processing document, a spreadsheet, or an executable program. For example, an event hyperlink (which will be described in detail below) may be embedded in a web page or an application program. Web pages may be constructed, for example, using Hypertext Markup Language (HTML) or a development environment, such as Macromedia® Dreamweaver®, which is commercially available from Macromedia of San Francisco, Calif. Applications programs may include Microsoft®, Office PowerPoint®, Excel®, or Word®, which are commercially available from the Microsoft Corporation. Within the application, one or more hyperlinks may be configured to execute automatically (e.g., in response to a predetermined event or at predetermined times), or in response to user input. In one embodiment, an executable program may be configured to schedule a hyperlink to execute automatically at a predetermined time of day, for example, to send a command to a relay device to turn off lights in a room after normal work hours.

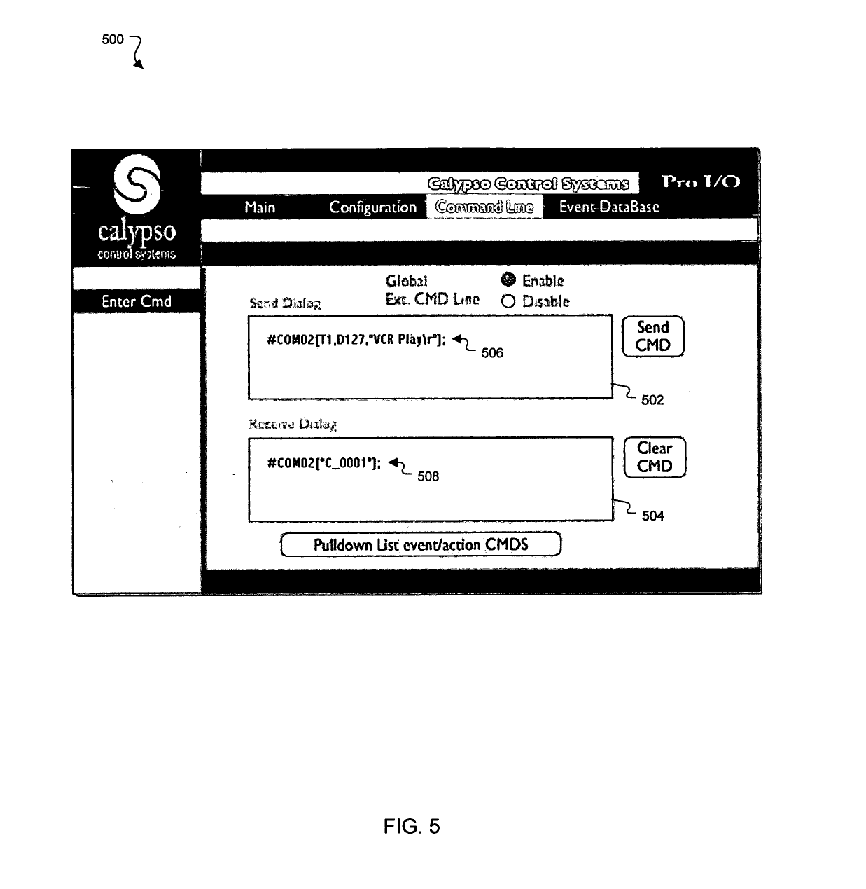

In one implementation, the I/O server 102B may send a command over the network 106 to the I/O server 102A, for example, to initiate an event. The I/O server 102B may also send a command directly to an I/O device connected to the I/O server 102A. The event hyperlink accessed by a user of the client device 104A may trigger an event at the I/O server 102B. The triggered event at the I/O server 102B may be associated with an action to send a command over the network 106 to the I/O server 102A, which may be located at a remote conference room where other users are viewing the slide show. Further according to this example, the command sent to the I/O server 102A may trigger an event that is associated with an action to send a relay command to the relay device 108 to dim the lights in the remote conference room. In another example, the I/O server 102B may directly address and control the relay device 108 using a command line interface (as described below with reference to FIG. 5). The I/O server 102B may send a relay command via the network 106 and the I/O server 102A.

Advantageously, in some embodiments, the user at the client device 104A may select an event hyperlink to trigger an event in one or more of the I/O servers 102 while continuing to operate in the application program environment substantially without interruption. Accordingly, the user does not need to exit or interrupt a slide show presentation, for example, to control various I/O devices. The user may control an I/O device from within the slide show application program by selecting or otherwise activating a hyperlink within the slide show. In one implementation, for example, the user may select an event hyperlink within an application program to control an I/O device, such as a relay configured to control the lighting in a room, or to deploy or retract a display screen.

In the example of FIG. 1, I/O expansion modules 124A-124N are coupled via a network 126 to the I/O server 102A to provide additional inputs and outputs to the I/O servers 102A-102N. In one implementation, the network 126 may conform to any suitable network standard interface and protocol, such as RS-485, for example. In this example, the I/O expansion module 124A connects to a relay device 128, the I/O expansion module 124B connects to a serial device 130, and I/O expansion module 124N connects to an IR device 132, as indicated by arrows 134, 136, and 138 respectively.

In certain embodiments, each of the I/O expansion modules 124A-124N may be configured to automatically detect and self-configure, under software control, a termination impedance for the interface to the network 126. In an RS-485 application, the network 126 may self-detect appropriate electrical characteristics and, in communication with other I/O expansion modules 124A-124N, each I/O expansion module 124A-124N may determine which is the last (most remote) expansion module on the network 126 and set the interface termination accordingly.

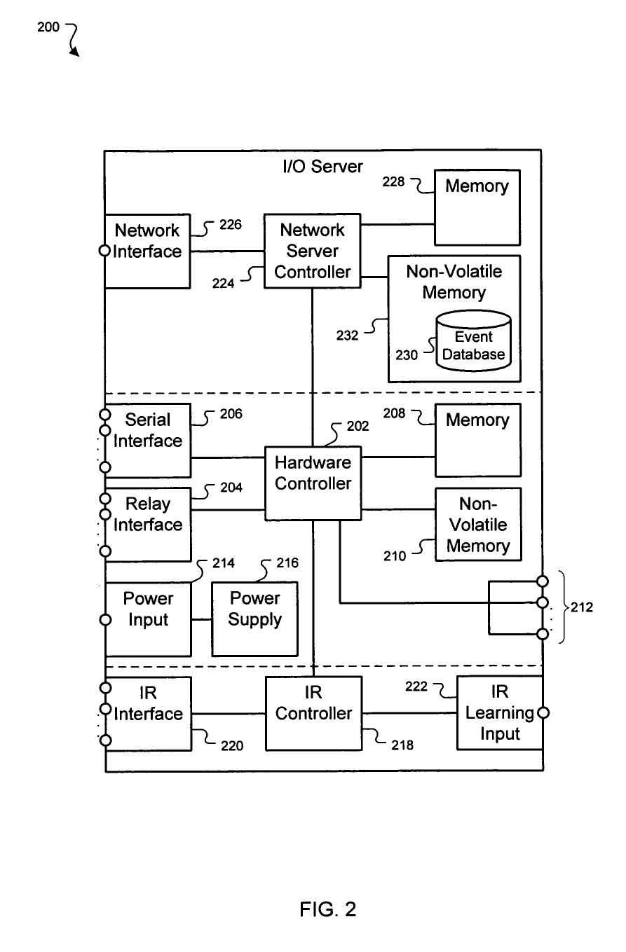

The I/O servers 102A-102N may each receive inputs from the client devices 104A-104N, another I/O server, or an I/O device to trigger events that result in the I/O server activating one or more outputs. An implementation of one of the I/O servers 102A-102N is shown as an exemplary I/O server 200 in FIG. 2.

The I/O server 200 includes a hardware controller 202 that may receive data at a relay interface 204 or a serial interface 206. For example, the relay interface 204 at the I/O server 102A may receive the relay input 114 from the relay device 108, or the I/O server 102A may send a serial output 116 to the serial device 110 through its serial interface 206. The relay interface 204 may contain one or more inputs and one or more outputs. The serial interface 206 may contain one or more input/output connections that may be interoperable with one or more hardware interfaces and one or more protocols. The hardware controller 202 may store data in a volatile memory 208 or in a non-volatile memory 210. The I/O server 200 of this example includes visual indicators 212, such as light emitting diodes (LEDs). The indicators 212 may show activity at a particular input or output interface. The I/O server 200 also includes a power input 214 and a power supply 216 that provide regulated voltage and/or current to the I/O server 200. Various embodiments may receive electrical power from a DC supply (e.g., 9-12 Volt), an AC supply (e.g., 50/60 Hz, 110/220 Volts), or from a stored energy source such as a battery.

The I/O server 200 also includes an IR controller 218 that may receive and/or send IR signals through an IR interface 220. The IR interface 220 may contain one or more inputs and one or more outputs. In addition, the I/O server 200 may include an IR learning input 222. The learning input 222 may pass an IR signal to the IR controller 218 to determine the command format of the IR signal received at the learning input 222. In one embodiment, the I/O server 200 may receive and send IR inputs and outputs, respectively, as unmodified streams of data, using a standard or non-standard time encoding to denote divisions between data bits. In another embodiment, the I/O server 200 may translate IR input data into a standard format, such as the Sony® IR remote control code format, and it may translate IR output commands in a standard format into IR output data.

In one example, a user may desire that two digital video disk (DVD) players at different locations play a DVD at the same time. The I/O server 200 may receive a “play” IR signal at its IR interface 220 from a user operating a local DVD player with an IR remote control device. With reference to FIG. 1, the IR signal may trigger an event at the I/O server 102A to relay the same command through the network 106 to a remote I/O server 102B. The command may be output to another DVD player at the remote I/O server 102B through its IR interface 220. In various embodiments, an event can be configured to cause a chain of event triggers to multiple I/O servers.

In another example, a user may direct the DVD player remote control at the learning input 222 while pressing the “play” button on the remote control. The learning input 222 may pass the IR signal for the “play” action to the IR controller 218 where the command format may be determined. Once the command format is determined, the user may enter the command format for the “play” action as a trigger input or an output action in an event.

The I/O server 200 includes a network server controller 224 that receives network data through a network interface 226. The network interface may be, for example, a network interface card (NIC), and the network may be, for example, Ethernet or Firewire®. With reference to FIG. 1, the network server controller 224 at the I/O server 102A may receive a hyperlink request from a user at the client device 104A through the network interface 226. The network server controller 224 may store the request in a volatile memory 228. The network server controller 224 may then identify the event ID contained in the hyperlink, and retrieve the corresponding event data from an event database 230 stored in a non-volatile memory 232. The event data may be used to determine what actions should be executed as a result of the hyperlink trigger.

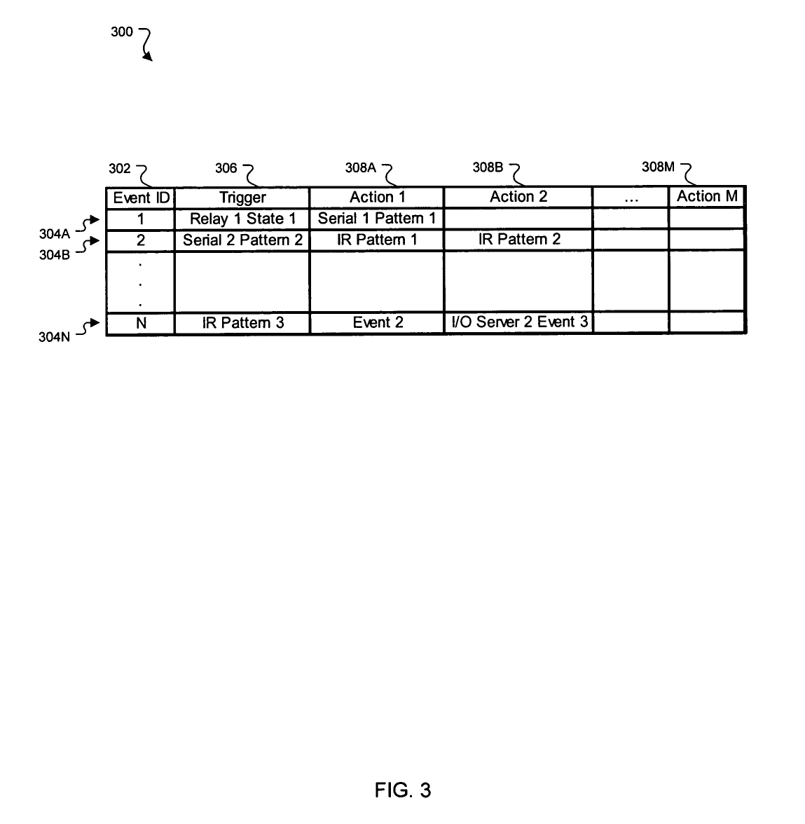

FIG. 3 is an exemplary data table 300 showing exemplary parameters and exemplary data structures that may be stored in the event database 230 of FIG. 2. The data table 300 is structured as an NxM array of N rows and (M+2) columns. Each of the N rows 304A-304N may be associated with an event identifier (event ID) 302, an event trigger 306, and up to M actions 308A-308M. The number of rows N and the number of actions M may be any practical numbers, and may be as large as available memory space permits. In some examples, the maximum size of the data table 300 may be adjusted, for example, by increasing the size of the non-volatile memory 232, or by providing additional memory in the form of a data storage device, cache memory, or remote storage that the I/O server 200 may access via the network interface 226.

For example, a relay input 1 changing to state 1 may trigger event 304A. Once triggered, event 304A will result in sending an output pattern 1 to serial interface port 1. Alternatively, a hyperlink to the I/O server containing the event ID, an action in another event, or an action in an event at another I/O server may explicitly trigger the event 304A. For example, when IR pattern 3 is received by the I/O server, the I/O server will execute the actions associated with event 304N. These include triggering event 2 (i.e., the event 304B) and triggering an event 3 at another I/O server, namely I/O server 2.

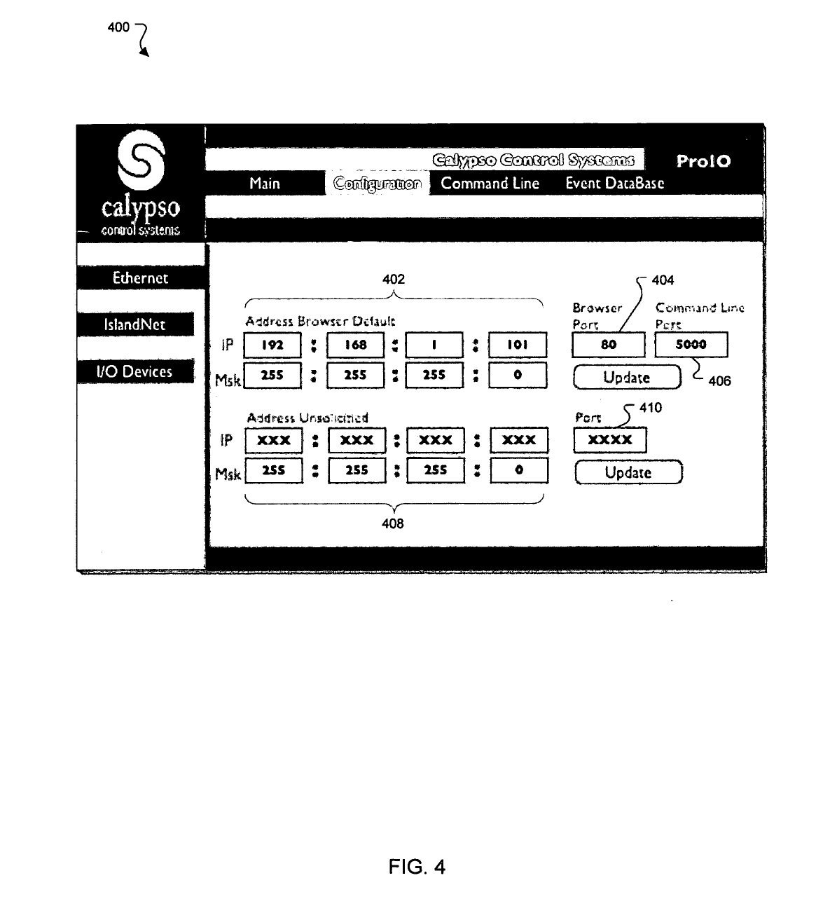

If the network 106 of FIG. 1 is a Transmission Control Protocol/Internet Protocol (TCP/IP) network, the I/O servers 102A-102N may be associated with an IP address, or a name that can be resolved to an IP address, in order to locate another I/O server when initiating a remote event or command. Client devices 104A-104N accessing I/O servers over the network 106 may also require the IP address or name of the I/O servers when using TCP/IP. FIG. 4 shows an exemplary web based GUI display 400 where a user may configure the IP address and subnet mask 402 of an I/O server. Additionally, the GUI allows a user to specify a web browser port 404 and a command line port 406. Invalid inputs received by the I/O server may be forwarded to an IP address, a subnet mask 408 and a port 410 specified for “unsolicited” messages. In some embodiments, the network 106 of FIG. 1 may be any suitable network type, examples of which include the Internet, an intranet, extranet, virtual private network (VPN), local area network (LAN), wide area network (WAN), wireless local area network (WLAN), or similar wired, optical, wireless, or hybrid network capable of transmitting messages from a client device to an I/O server in response to selection of a hyperlink.

A user may view and test the format of inputs and outputs using an exemplary command line GUI display 500 of FIG. 5. This exemplary display 500, which may be displayed on a display device coupled to one of the client devices 104, includes a send dialog 502 where outputs may be entered and a receive dialog 504 where the format of inputs may be viewed. In this example, an output command 506 being tested is a serial output to the second serial interface in American Standard Code for Information Interchange (ASCII) format with a delay of 127 units and a message including “VCR play\r” where “\r” is an ASCII return character. A serial input response 508 received from the serial device, in this example a VCR, resulting from the serial output “VCR play\r” is “C—0001” which indicates that the command was successfully executed by the VCR. Alternatively, an output format may be specified that indicates a particular input should be monitored for input format capture. For example, an output format may be specified in the send dialog 502 indicating that a particular IR input interface should be monitored. A user may then activate an IR device, such as by pressing the “play” button on a DVD player remote control, and the format of the IR signal from the IR device may be captured and displayed in the receive dialog 504.

The command line may also be accessed directly by opening a network connection to the IP address of the I/O server and the port of the command line specified on the GUI display 400 of FIG. 4. The commands entered in the send dialog 502 above may be sent to an I/O server over this direct connection. The replies seen in the receive dialog 504 above may be received over the direct connection following the send command.

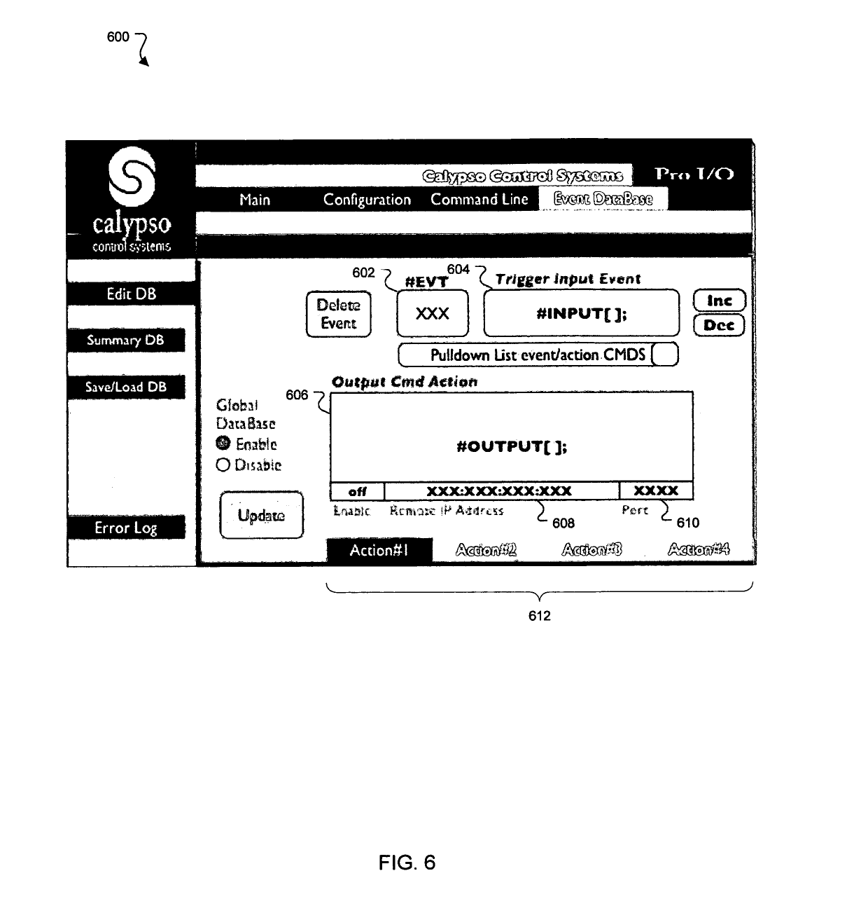

Once input and output format information to execute a desired event are known, they may be entered as triggers (input) and one or more associated actions (outputs) in an event database. FIG. 6 shows an exemplary GUI display 600 in which events may be configured by an end user. In this example, a user may enter an event ID 602, an event trigger 604, and an output command action 606. The output command action 606 may have a corresponding remote I/O server IP address 608 and a port 610. A user may enter multiple command actions 612 for each event. This GUI display 700 allows a user to configure an I/O server without the need for extensive product design information or programming skills. This configuration display 700 does not require special training or detailed software programming.

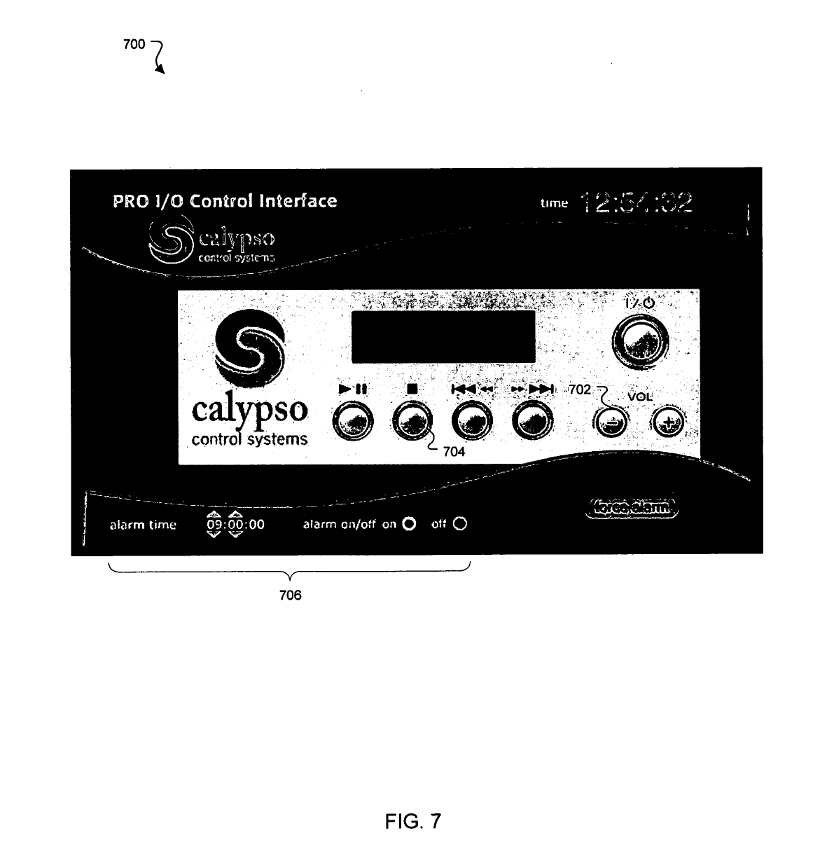

Events configured in the event database may be triggered by event hyperlinks that are embedded in web pages or other applications running on a computing platform that is coupled to communicate with an I/O server. FIG. 7 shows an exemplary user interface display 700 in which users at client devices 104A-104N, for example, may initiate events at an I/O server using event hyperlinks. The user interface display 700 of this example includes a graphical representation of a CD player corresponding to the actual controls on a physical CD player. The buttons in the graphical representation have embedded hyperlinks containing event IDs for events that contain actions for executing the corresponding commands on a physical CD player. For example, the “Vol—” button 702 in the graphical representation may be associated with an event hyperlink containing an event identifier for an event that sends an IR output action to a CD player to decrease its volume. Alternatively, if the CD player is coupled to the I/O server via a serial connection, by selecting the event hyperlink for the “stop” button 704, the I/O server may send a serial output action from the I/O server to put the CD player in a “stop” state.

In addition to input triggering, hyperlink triggering, event triggering, remote triggering, and command line triggering, an I/O server may provide the capability to schedule a triggering event. In one embodiment, for example, the I/O server may contain a real-time clock and it may be time synchronized to an accurate reference time source, which may be a network timeserver, such as that available at: http://www.nist.gov. In another embodiment, the I/O server may synchronize to the clock of the client device sending a hyperlink to the I/O server. The user interface display 700 contains event scheduling parameters 706. The scheduling parameters 706 in this example schedule the CD player to begin playing every day at 9:00am. Alternatively, a number of times to repeat may be specified, start and stop times and dates may be specified, or a period other than 24 hours may be specified.

In one implementation, the event hyperlinks described above may contain a link to a Common Gateway Interface (CGI) program within a Uniform Resource Locator (URL). The following is an exemplary URL containing a link to a CGI program: http://192.168.0.1/button.cgi?event=1, where “192.168.0.1” is the IP address of the I/O server, “button.cgi” is the CGI program, and the parameter passed to the CGI program, “event=1,” is the event ID. Due to the I/O servers 102A-102N being connected to the network 106, which may be a wide network such as the Internet, the client devices 104A-104N at which users select hyperlinks may be physically located remotely from the I/O servers 102A-102N that are receiving the hyperlink request.

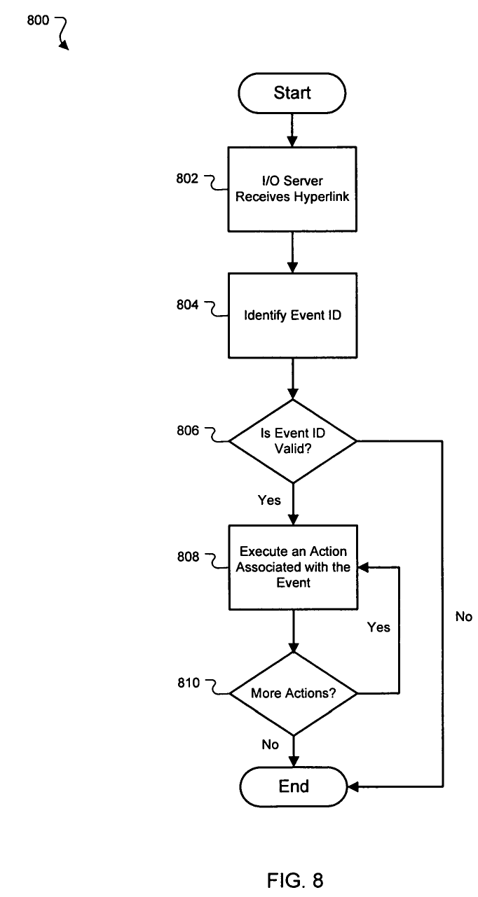

An I/O server may go through various steps when executing the actions in the previous example. FIG. 8 is an exemplary set of operations 800 that may be performed when an I/O server receives a hyperlink request and executes actions associated with the hyperlink request.

The operations 800 begin, in step 802, with the I/O server receiving a hyperlink request. For example, in the exemplary I/O control system 100 of FIG. 1, a user may select a hyperlink on a web page displayed at the client device 104A. The hyperlink may be directed to the I/O server 102A.

In step 804, the I/O server identifies any event ID contained in the hyperlink. For example, I/O server 102A may receive a hyperlink request from a user at client device 104A containing an identifier “1.”

In step 806, the I/O server may validate the event ID received in the hyperlink. If the event ID does not exist, then the I/O server may discard the hyperlink request. If the event ID is valid, then the I/O server may continue its processing. For example, the I/O server 102A may verify that the event ID “1” received in the hyperlink corresponds to the event 304A.

In step 808, the I/O server executes an output action associated with the event. For example, event 304A sends a serial output pattern 1 to a serial interface 1. In step 810, the I/O server determines if more actions are associated with the event. The I/O server may repeat step 808 until all actions associated with the event have been executed.

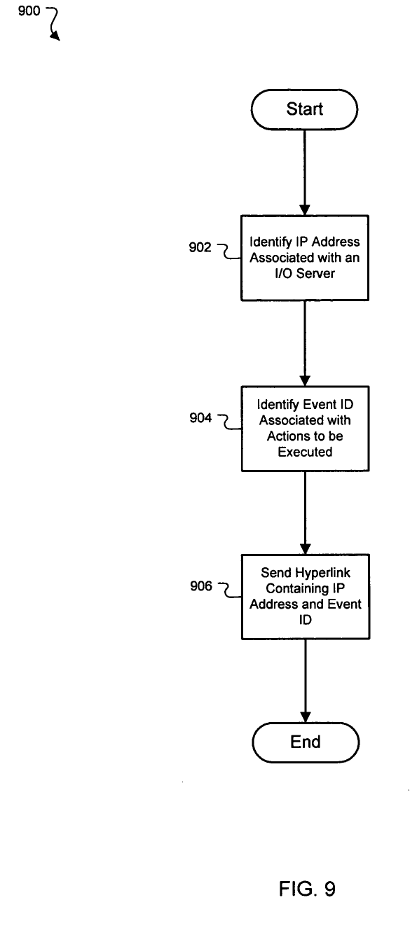

When a user defines a hyperlink that will be used to initiate events at an I/O server, various steps may occur. FIG. 9 is an exemplary set of operations 900 that may be performed when assembling a hyperlink to initiate events at an I/O server.

In step 902, an IP address associated with an I/O server is identified. For example, the hyperlink for a particular I/O server may include the IP address of the I/O server. Alternatively, the hyperlink may contain a name that can be resolved to an IP address or a network address.

In step 904, an event ID of an event associated with the actions to be executed is identified. For example, in the exemplary data table 300, if the desired action is a serial pattern 1 sent to a serial interface 1, the event ID would be “1.”

In the final step 906, the event hyperlink containing the IP address and event ID is sent to the I/O server. For example, after adding a hyperlink containing the IP address of I/O server 102A and the event ID “1” to a web page, a user at a client device 104A may select the event hyperlink to send the request to I/O server 102A resulting in the execution of the actions associated with event ID “1”. Steps 902 and 904 may occur in any order or at the same time.

The I/O control system 100 allows users to control one or more I/O devices over a network 106.

Through the event database 230, the I/O control system 100 allows I/O devices having proprietary communication formats to be controlled using a common approach that does not require specialized knowledge of the I/O devices being controlled, or sophisticated programming skills. The event database 230 may be defined by entering triggers and actions for each event on the event configuration display 600 shown in FIG. 6. The IR learning input 222, the command line display 500 of FIG. 5, I/O server documentation, or proprietary documentation provided with the I/O device may be used to determine the format of commands entered as triggers and actions. Once the event database 230 has been built, a user with basic web page building skills may develop a web page similar to the user interface display 700 of FIG. 7.

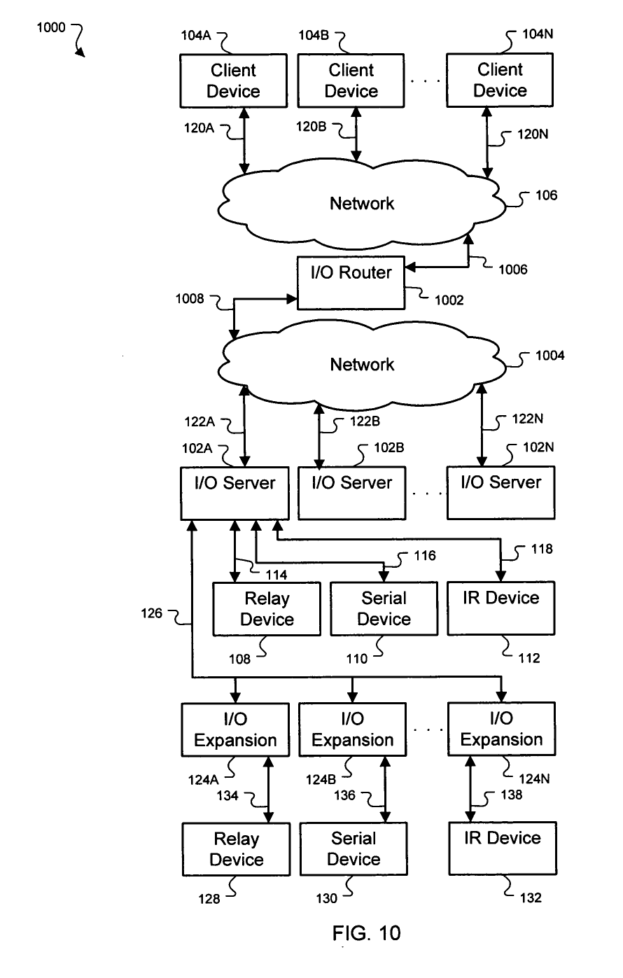

The I/O control system 100 can be designed so that the user building web pages with event trigger hyperlinks does not need to know the network addressing of the I/O servers 102A-102N. In addition to the I/O control system 100 components of FIG. 1, FIG. 10 shows an I/O router 1002 that may be used to direct hyperlinks from the client devices 104A-104N to the I/O servers 102A-102N. This allows users to send hyperlinks to a single location (i.e., the I/O router 1002) on the client device network 106. The I/O router 1002 receives hyperlink requests from the client devices 104A-104N on the client device network 106 and routes the hyperlink requests to the appropriate I/O servers 102A-102N on an I/O server network 1004, as represented by arrows 1006 and 1008 respectively. In addition, changes may be made to the I/O server network 1004 without affecting the web pages, because the hyperlinks no longer need to contain individual I/O server addressing information. In some embodiments, the router 1002 performs network address translation (NAT) operations, and may also provide for dynamic host configuration protocol (DHCP) in addition to static addresses.

Many modem operating systems and application programs support hyperlinks. Accordingly, devices may be controlled over a network user hyperlinks, and without custom user-defined, proprietary, or platform-dependent drivers or programs. The I/O server may translate between inputs and outputs that are not directly compatible. This may extend the capabilities of some devices to control or be controlled. The control translation may be transparent to the user and the client device. Any client device with hardware and/or software capable of issuing a hyperlink has the potential to control an I/O device, once the I/O server translates the hyperlink trigger into an output action. Such client devices may include, for example, desktop computers, laptop computers, personal digital assistants, or web enabled cellular phones.

The document attached to the end of this application includes exemplary command line formats for input and output commands, as described above with reference to FIG. 5, for example. The commands may be used as triggers or output actions for events.

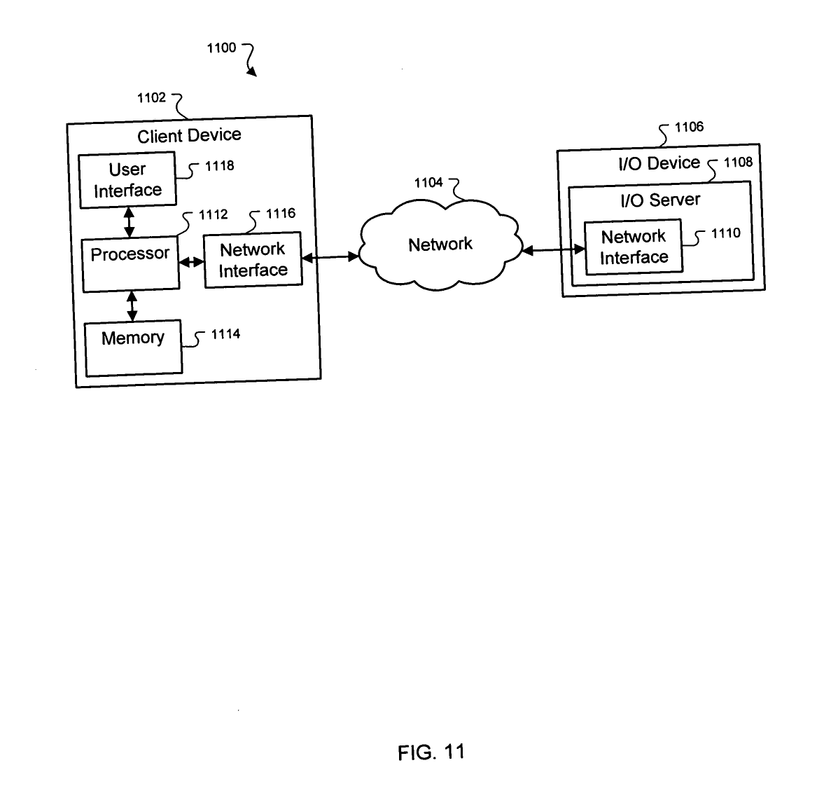

In one implementation, the functionality of an I/O server may be integrated into a controllable device, such as one of the devices 108-112. FIG. 11 shows an exemplary system 1100 including a client device 1102, a network 1104, and an I/O device 1106.

In this example, the I/O device 1106 contains an I/O server 1108. The I/O server 1108 may contain a network interface 1110 that provides communication with other devices on the network 1104. The client device 1102 may contain a processor 1112 coupled to a memory 1114, a network interface 1116, and a user interface 1118.

Similar to the I/O control system 100 of FIG. 1, a trigger signal to initiate a hyperlink at the client device 1102 may cause a hyperlink to be sent through the network interface 1116 and over the network 1104 to the network interface 1110 of the I/O server 1108 contained in the I/O device 1106. The I/O device 1106 may be any device that can be controlled by the I/O server 1108, such as a relay device, a serial device, or an IR device. In one embodiment, the I/O device 1106 may be a web-enabled video camera capable of accepting control commands from a hyperlink sent over the network 1104.

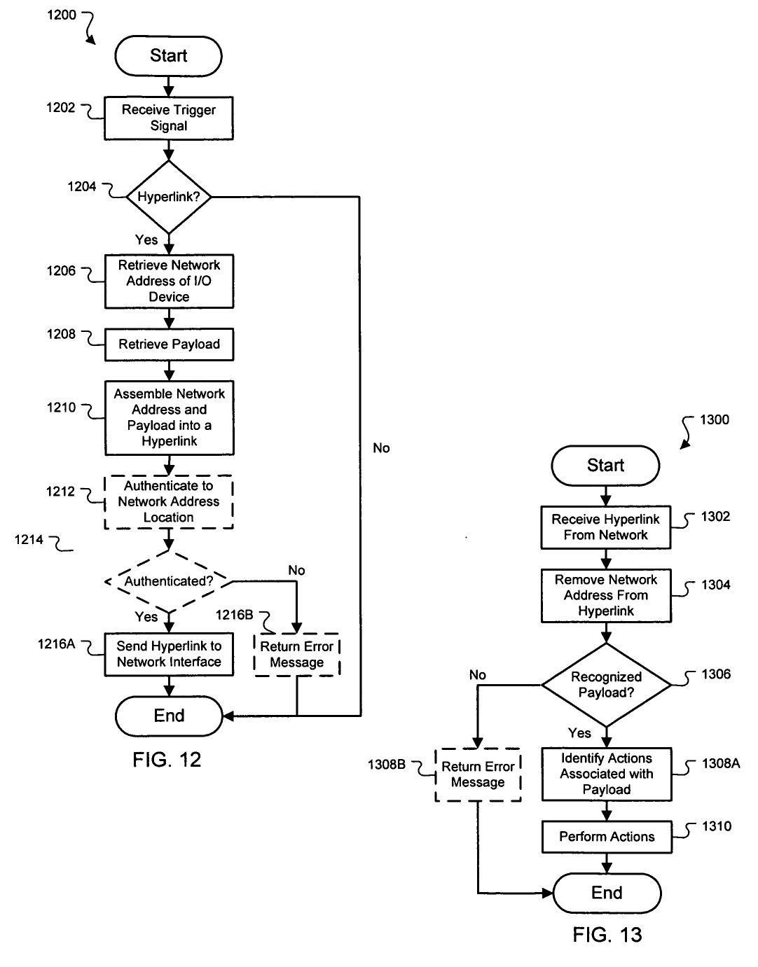

The steps involved in using a hyperlink to control an I/O device may be described with reference to operations performed by the sender (e.g., client device 1102) and the receiver (e.g., I/O device 1106). FIG. 12 is an exemplary set of operations 1200 performed at a client device where a hyperlink is requested. FIG. 13 is an exemplary set of operations 1300 performed at an I/O server when processing a hyperlink control to an I/O device.

The operations 1200 begin in step 1202 where a trigger is received. For example, a user at the client device 1102 may select the button 702 on the user interface 700 of FIG. 7.

If the trigger includes a hyperlink (step 1204), the processor 1112 may retrieve a network address that is stored in the memory 1114 and that identifies an I/O server or device, in step 1206. In step 1208, a payload may be retrieved from the memory 1114. The payload may contain, for example, an identifier such as the event identifier to execute event 304B of FIG. 3, for the control or controls that will be executed at the I/O server or device. In another example, the payload may include a command in a command line format, as described with reference to FIG. 5. In step 1210, the network address and payload are assembled into a hyperlink.

In optional step 1212, access to the I/O server or device may be authenticated. For example, authentication may be in the form of a user name and password that are sent to the I/O server 1108 in the device 1106. In another example, authentication may include a key contained in the payload of the hyperlink.

If the authentication is successful, in optional step 1214, the hyperlink may be sent to the network interface, in step 1216A, otherwise an error message may be returned, in optional step 1216B. Steps 1212, 1214, and 1216B may occur in a different sequence in the operations 1200. For example, the client device may authenticate to the I/O server or device before the user selects the button. In addition, steps 1206, 1208, and 1210 may occur at a different location in the operations 1200. For example, the hyperlink may be assembled before the user selects the button.

When the I/O device 1106 receives the hyperlink, it may process the hyperlink according to the following exemplary set of operations 1300 shown in FIG. 13. The operations 1300 begin with the I/O device 1106 receiving the hyperlink request from the network, in step 1302.

In step 1304, the network address may be separated from the payload. If the I/O server 1108 recognizes the payload in step 1306, the I/O server or device may identify actions associated with the payload, in step 1308A, otherwise an error message may be returned, in optional step 1308B. In step 1310, the actions associated with the payload contained in the hyperlink are performed.

Some commercially available IR devices, which may include, for example, audio equipment and associated remote control devices, may send or receive IR data transmissions that comply with the protocols and code definitions from equipment vendors. Accordingly, the IR interface 220 or the IR learning input 222 may operate according to defined protocols. One exemplary, commercially implemented protocol, is the Sony SIRC Protocol, which uses codes represented by predetermined modulation patterns that correspond to defined bit lengths, such as 2 bytes. Decoding hardware and/or software may translate a received modulation pattern into data bits or bytes. In some embodiments, the data bits or bytes may be translated into a predetermined English-readable command, such as “channel increase” or “mute,” for example. In another example, the IR protocol may involve a universal code that may be, for example, 240 bytes long. Such codes may also be communicated using the command line format, described above with reference to FIG. 5, or in the payload of a hyperlink. When transmitting IR codes, the I/O server may be configured to select appropriate protocols, formats, and codes for compatibility with the target device.

As an illustrative example, a user may configure an I/O server to translate IR inputs which may be in Sony SIRC codes format. The user may define a trigger event by entering the appropriate 2 byte code into the input field 502. Using the interface 500, IR codes defined by other commercial suppliers, or the user, may be translated, used, or identified. Any of such codes may also be used to define IR codes as event triggers or actions using the interface 600. In one example, the I/O server may be configured to translate IR commands output by a VCR remote control that uses one IR protocol to control multiple elements of a professional audio-visual presentation system, which may involve general purpose I/O, serial communication, and network messaging. In a particular example, the IR signals generated by pressing keys on the keypad of the VCR remote control may be re-mapped using the event database of an I/O server to control a sequence of events in a theatrical presentation, such as dimming the lights, opening and closing the curtain, and muting selected microphone mixer channels, as needed.

In other implementations, the I/O server may be assigned either a static or a dynamic network address. A static network address may provide stable and direct addressability of a particular I/O server from any access point on the network. Dynamic network addressing may also be used advantageously, for example, by organizations that have large internal networks in which static addresses and/or direct access of a large number of internal network nodes to an external network may be less desirable due, for example, to security or maintenance concerns, for example.

Some implementations may optionally provide for alternative storage and/or access to information in the event database. In some implementations, a service provider may make libraries of event database information available over a network, such as the Internet. Event triggers and associated actions may, in various examples, be stored either locally, in the I/O server, on a nearby data storage device coupled via a serial connection, or remotely, such as in an information repository that the I/O server may access via a network. Local storage in the I/O server may consist of pointers to the remote physical storage locations of actual event trigger data or action data.

In other implementations, the event trigger data and the associated output action data need not be static. For example, the physical data representing event trigger and/or action data may be replaced dynamically to reflect changing times of day, different users, and their different security levels. Event database information may also be dynamic to permit rapid reconfiguration according to predetermined profiles associated with application programs. Such dynamic data capabilities may permit a wider arrange of applications to be used, and reduce even further the burden of configuring an event database. In an alternative implementation, an index table containing pointers to the physical data being stored may be dynamically updated to point to events and associated triggers according to one or more profiles. In yet another implementation, one or more of the event triggers or actions may be computed dynamically based upon packets of information, for example, received over the network.

Users may configure the event database, and specifically links between event triggers and their associated actions, by entering the appropriate information into the exemplary GUI 600. In other embodiments, users may define the information contained within the event database using other mechanisms. For example, some or all of the information may be initially configured using a predetermined process to download a set of information into a memory of the I/O server. In still other embodiments, the user may manually enter information into the database using a user interface that included other input fields, or input fields displayed as drop-down list boxes, or radio buttons, for example.

Some implementations may include at least one I/O server configured as a hub directly connected to a network and for controlling a set of general purpose inputs and outputs. In some other implementations, the I/O server may be coupled externally to a housing of a device, such as a DVD player. In other embodiments, one or more I/O servers may be incorporated into a device housing, for example, to provide a network interface for the device. In an embodiment, a single I/O server may be dedicated to a single hardware device or product, such as a video camera, a multi-channel mixer, or a projection system, for example.

Moreover, the ability of the I/O server to communicate with other devices coupled to a network provides for functionality that may include remote troubleshooting by trained service personnel from any access point on the network, updating programming or application software, and downloading application or program data. Accordingly, the I/O servers that are connected to a world-wide network, such as the Internet, may be monitored or maintained by remotely located personnel (i.e., experts) who have access to the Internet.

In an alternative embodiment, events may be determined dynamically without reference to an event database. For example, the I/O server may process information packets containing control and/or parameter information in a header or payload of a network message. The I/O server may execute a program of instructions that can interpret the information received. Based on the interpreted information, an appropriate control command or action may be executed. In one example, a control command may be received that is associated with a “power down” instruction. Upon interpreting this instruction, the I/O server may open all relays, and send an appropriate “power down”serial command to each active serial port and the IR port. Accordingly, the I/O server may dynamically determine some responses to triggers without accessing a database.

In another embodiment, the I/O server may execute program instructions or be configured in hardware, or a combination thereof, to respond to commands by calculating an appropriate response. In this embodiment, the I/O server may determine what I/O devices it is coupled to, either by auto-detection, communication with some or all of the connected devices, by receiving user input that defines how one or more of the devices are configured, or based upon a default configuration. In the default configuration option, certain I/O are coupled to predetermined ports in a predetermined way. For example, overhead lights are on general purpose output ports 0-2, motorized projection screen deploys when relay0 is closed and retracts when relay1 is closed. Intelligent devices, such as some projection equipment, may communicate with the I/O server to identify itself. Accordingly, in response to a network command such as “lights off, start projector,” the I/O server can intelligently determine the sequence of events to perform and send appropriate control commands to the appropriate I/O ports. If the projection system requires 30 seconds to synchronize with a laptop and warm-up, for example, the I/O server may delay turning off the lights for at least 30 seconds after turning on the projector. In addition, a network command may further include a command sequence, such as, “turn on projector—delay 10 seconds—deploy projector screen—delay 5 seconds—turn on soundtrack—delay 10 seconds—dim lights.”

In a further embodiment, the I/O server may be configured to assess commands, including hyperlink commands, for their suitability. If, for example, while a video is playing and the lights are dimmed, the I/O server could be programmed to assess and filter individual events or actions that would turn on the lights or restart the video. A priority level may be configured to provide for high priority commands to override the filter.

I/O servers, such as those described herein, may be used advantageously in a variety of applications. For example, audio-visual equipment, lights, and projection screens in a boardroom or classroom may be controlled from a remote location. Systems may be deployed, for example, to provide for controlling simultaneous presentations in multiple locations. In another application, the a broadcast control center may send control commands and receive status information from a remote camera and microphone that is coupled to a network interface, such as a wireless internet connection, for example.

In some embodiments, hyperlinks include an element in an electronic document or application that links to another location in the same document or application, or to a different document or application. In an embodiment, a hyperlink uses the following URL command sent via the Internet to cause a control event to trigger within a target device, such as an I/O server:

http://192.168.0.101/button.cgi?Event=X where the IP address (192.168.0.101) portion is one exemplary address of a target device, and “X” in the payload (button.cgi?Event=X) portion is the event identifier that the target device (i.e., an I/O server with an event database) associates with an action to be performed.

A method of using hyperlinks to control a device includes receiving a command that includes a payload portion, the command being received by a device coupled to the network to receive the command. The method further includes identifying a predetermined action associated with the payload portion of the command, and then performing the identified action.

In embodiments of this method, the command may be a hyperlink command. In some embodiments of the method, the network hyperlink command may be formatted in a hyper text transfer protocol (http), or in an XML format. Hyperlink commands may comprise a network address portion and the payload portion. The network address portion may contain information that indicates a URL or an IP address. In some cases, the network address may be static or dynamically assigned according to a DHCP protocol.

The payload portion may comprises a common gateway interface (cgi) command, as described above. When received by the network server, the cgi script may be executed, and the arguments of the cgi command may be interpreted. By placing event identifiers in the argument of a cgi script, a hyperlink may be used to trigger a predetermine event associated with that event identifier. Alternatively, the payload may contain a hardware command string that, when received by a target hardware device, is interpreted and processed to cause the target device to perform a predetermined action. In some embodiments, the payload may contain a port identifier associated with the port of an I/O server to which the target device is coupled.

The operating system of a client device, for example, may be configured to process such a command by sending it over a network. Once on the network, the command may be routed to the device having the corresponding network address. The device that receives the command may be coupled to the network at a network address that corresponds to the network address portion.

Portions of the network over which the hyperlink may be communicated may include Internet, LAN, WAN, wireless network, and/or VPN. In some cases, a router hub may receive a hyperlink from a first network, determine the appropriate location to route the payload, and forward the payload to the proper address on a second network. In the process, the router may also strip off the network address information associated with the router itself before forwarding the payload information.

The identified action performed by the target device may involve performing a plurality of predetermined actions, such as up to 4 predetermined actions, or more than 4 predetermined actions. The performed actions may involve sending a command to a second device (or multiple additional devices). Messages to additional devices may be communicated over the network, or via a serial, IR, or general purpose interface, for example. As such, the identified action may involve sending at least one network command to at least one network device.

In some embodiments, the hyperlink may contain a payload with an event identifier that is associated with one or more actions to be performed in an event database. The event database may be user-configurable, for example, by using a user interface according, for example, to the following method.

A method of defining events using a user interface includes receiving in a user interface information to identify a trigger. The method further includes receiving in the user interface a command to be sent to a target device in response to receiving the trigger. The command is configured to cause the target device to perform at least one predetermined action. The method also includes mapping the received information to identify the trigger and the associated command.

In embodiments of the method, the user interface may include a graphical user interface, which may contain, for example, various user input controls, such as a dialog box, one or more input fields for receiving user text input, user input controls (e.g., radio buttons, slider scales, check boxes, drop down list boxes). In a particular embodiment, the user interface may include a graphical representation of a man-machine interface (MMI).

In some embodiments, the trigger comprises a signal received at a general purpose input port, such as a serial, IR, or relay signal. The trigger may also be generated at one or more predetermined times. For instance, an event or event sequence may be triggered at one or more times. Times may be referenced to a client, network, or user-defined time. A network message may also serve as a trigger. In this way, one event in an event database may serve to trigger an event in a second database. Each event may be associated with multiple actions. One example of a triggering network message is a hyperlink command, described elsewhere in this document. The trigger may also occur in response to an executed program instruction.

In some embodiments, the command to be sent to a target device includes a code. In some cases, the code may be defined by the manufacturer of the target device. The command may be associated with a predetermined sequence of actions, as described, for example, with reference to the event database 300 of FIG. 3.

By way of example, various embodiments of the method may use as a target device audio/video equipment, an electromechanical device, a switch, a relay, serial interface, IR device. In some examples, a target device may be an I/O server.

In various embodiments of the method, the mapping may involve associating the trigger and the associated command in a database, as described, for example, with reference to the event database 300 of FIG. 3. Any practical number of triggers may each be associated with one or more actions to be performed. The information in the event database may be stored locally in a memory in the I/O server, or stored remotely. Locally, a particular I/O server may store only pointers to locations containing actions to be performed in response to a trigger.

In various embodiments, hyperlinks may be used in web pages, PDF documents, word processing documents, or spreadsheets, for example. There are a number of ways to format and present hyperlinks on a web page. The embedded link, is one possible format. A web browser, for instance, may display an embedded hyperlink in some distinguishing way, e.g. in a different color, font or style. The behavior and style of links may be specified using the Cascading Style Sheets (CSS) language.

In a graphical user interface, the usage of a mouse cursor may also change into a hand motif to indicate a link. In most graphical web browsers, links are displayed in underlined blue text when not cached, but underlined purple text when cached. When the user activates the link (e.g., by clicking on it with the mouse) the browser will display the target of the link. Hyperlinks may be used with HTML files. If the target is not a HTML file, depending on the file type and on the browser and its plug-ins, another program may be activated to open the file.

In one exemplary embodiment, a method to control devices over an electronic communication network includes providing a hyperlink data structure in a memory coupled to a processor. The hyperlink data structure includes information about a network address for an event controller and a payload that includes a non-command formatted event identifier. Upon receipt by the controller, the non-command formatted event identifier causes the controller to issue one or more command formatted instructions that are associated with the event identifier in an event table. In the event table, each command formatted instruction is operative to control a corresponding target device. The method further includes receiving a command to execute the hyperlink, generating a message containing the payload portion, and sending the generated message to the network address.

In some embodiments of the method, the event identifiers may be integer numbers. At least one of the issued command formatted instructions may be received by the corresponding target device. A processor on the target device may perform operations in response to the received command formatted instructions. At least one of the issued command formatted instructions may include a second event identifier, and in some examples, the corresponding target device may include the same or another controller.

In various implementations, at least one of the issued command formatted instructions may control operation of a control element in the event controller. The control element in the controller may include a relay.

In some implementations, the action commands may include one or more hardware-specific commands to send to a controlled device to cause operations to be performed on the controlled device.

The command to execute the hyperlink may be received in response to user input. The method may further include sending a representation associated with the hyperlink for display by a display device. The hyperlink may be operatively embedded as a shortcut on a desktop of an operating system of a computer, and/or the hyperlink may be operatively embedded in an application program for a computer.

In some examples, the payload portion may contain one or two parameters. The application program may support passing a limited number of hyperlink parameters, such as up to 2 hyperlink parameters.

The method may further include generating a security token for the other of the parameters. Generating the security token may include encrypting identifying information about a MAC id or an IP address of the event controller or of the target device. The security token may be generated by encrypting the security token using a time-based token generator.

In another exemplary embodiment, an event controller may include a processor and a data store coupled to the processor. The data store may contain instructions that, when executed by the processor, cause the processor to perform operations. One of the operations includes receiving an electronic message that includes a non-command formatted event identifier. Another operation includes selecting from an event database one or more command formatted instructions associated with the received non-command formatted event identifier. Another operation includes causing each of the selected command formatted instructions to be executed on a target device associated with the command formatted instruction.

In some embodiments of the apparatus, the non-command formatted event identifier may be an integer number. In other embodiments, the non-command formatted event identifier may be an alphanumeric character.

Non-command formatted event identifiers are essentially very simple, easy to communicate, remember, type, and/or embed into an executable program. Having no direct relationship to specific hardware specific command-formatted commands, non-command formatted event identifiers simplify, for example, the programming burden on end users. The burden of translating the simple event identifier into hardware-specific command formatted commands is shifted to the event controller, which may typically be installed and configured to control target hardware devices by trained personnel.

The simplification provided to end users allows a wider audience of people to create and/or use commands that contain event identifiers. Such simple event identifiers promote the use, for example, of hyperlink commands by large number of end users who are not familiar with the details of the command formatted instructions required to operate and control specific target hardware devices. Accordingly, detailed knowledge of command formatted instructions (e.g., “TOGGLE POWER,” “VOL_INCREASE,”“PAUSE,” “FFWD,” or other hardware-specific command codes with hardware-specific formats) for each controlled device can be presented to the user as a simple number or letter. Moreover, any complex combination or sequence of actions may be associated in the event table with a simple event identifier (e.g., event “1,” event “2”) that can be easily embedded into a hyperlink, desktop shortcut, or other executable format.

Moreover, the event identifiers may be embedded in commands, such as hyperlinks, that are substantially platform independent. Hyperlink commands may work, for example, on various systems and application program platforms that support hyperlinks.

In some embodiments, the operating system of a computer may process some predetermined user inputs by generating an electronic message containing an event identifier, and causing that message to be sent to a network address. In some embodiments, a hyperlink embedded in an application program (e.g., Microsoft PowerPoint, Microsoft Word) with an event identifier payload may be processed by a system internet application that communicates with the system layer, which in turn sends the event identifier to the controller. In some examples, this may provide a bidirectional interface.

In another embodiment, the hyperlink embedded in an application program or a shortcut (e.g., desktop shortcut that may be activated by clicking on a shortcut icon on a computer desktop) may use a utility that bypasses the standard browser system. For example, the utility may be stored in the system registry on the computer. This may enable various flexible controls and security modes to be included. For example, the source and target devices may communicate securely by locking the sending and receiving devices together using an encryption key. In an illustrative example, a utility called “cnapx.exe” in the system registry may be executed by a call format: cnapx.exe 192.168.1.1010:5000 128. The name, “cnapx.exe” may be called, for example, by application programs, shortcuts, and/or hyperlinks.

In various implementations, application programs may limit the number of parameters that can be passed. In some embodiments, this limitation may be overcome by passing only one parameter which may be a single value or a complex string of values. The sending application may treat the string as a permissible single parameter, and the receiver (e.g., event controller) may parse the string into its intended component values.

Some embodiments may include various security features. For example, a unique MAC ID, source IP address, and/or encryption security key may be included in a second parameter or in the system registry. In some examples, either or both of the first and second parameters may be formatted as strings.

Not only can the commands be embedded in platform independent commands, such as hyperlinks for example, updates to controlled target hardware or software devices may be accomplished without changing the event identifier. Instead, hardware or software updates, product substitutions (e.g., different make, model, version, etc...), upgrades (e.g., to hardware and/or software), and the like, may be accommodated by simply updating the command-formatted commands as needed in the event table. Accordingly, maintenance costs in multi-user environments may be substantially reduced by maintaining the target device hardware and software, along with appropriate modification of the event table in the event controller. Accordingly, such maintenance may be transparent and disruption free from the perspective of the users. Moreover, event controllers in some embodiments may be remotely updated and maintained by, for example, a technician who generates, tests, and uploads update information to event controllers over an electronic network to which the event controllers are already connected. In some examples, remote maintenance may be performed over networks such as the Internet.

A number of embodiments have been described. Nevertheless, it will be understood that various modifications may be made without departing from the spirit and scope of the described embodiments. For example, advantageous results may be achieved if the steps of the disclosed techniques were performed in a different sequence, if components in the disclosed systems were combined in a different manner, or if the components were replaced or supplemented by other components. Accordingly, other embodiments are within the scope of the following claims.

What is claimed is:

1. A method to control devices over an electronic communication network:
providing a hyperlink data structure in a memory coupled to a processor, the hyperlink data structure comprising (1) information about a network address for an event controller and (2) a payload that includes a non-command formatted event identifier that, upon receipt by the event controller, causes the event controller to issue one or more command formatted instructions that are associated with the event identifier in an event table, wherein each command formatted instruction is operative to control a corresponding target device;
receiving a command to execute the hyperlink;
generating a message containing the payload portion; and,
sending the generated message to the network address.

2. The method of claim 1, wherein the event identifiers are integer numbers.

3. The method of claim 1, wherein at least one of the issued command formatted instructions is received by the corresponding target device.

4. The method of claim 3, wherein a processor on the target device performs operations in response to the received command formatted instructions.

5. The method of claim 1, wherein at least one of the issued command formatted instructions comprises a second event identifier.

6. The method of claim 1, wherein the corresponding target device is another event controller.

7. The method of claim 1, wherein the corresponding target device is the event controller.

8. The method of claim 1, wherein at least one of the issued command formatted instructions controls operation of a control element in the event controller.

9. The method of claim 8, wherein the control element in the controller comprises a relay.

10. The method of claim 1, wherein the command to execute the hyperlink is received in response to user input.

11. The method of claim 1, wherein the hyperlink is operatively embedded as a shortcut on a desktop of an operating system of a computer.

12. The method of claim 1, wherein the hyperlink is operatively embedded in an application program for a computer.

13. The method of claim 1, wherein the payload portion contains one or two parameters.

14. The method of claim 1, further comprising generating a security token for the payload portion.

15. The method of claim 14, wherein generating the security token comprises encrypting identifying information about a MAC id or an IP address of the controller.

16. The method of claim 14, wherein generating the security token comprises encrypting identifying information about a MAC id or an IP address of the target device.

17. The method of claim 14, wherein generating the security token further comprises encrypting the security token using a time-based token generator.

18. An event controller apparatus, comprising:
a processor;
a data store coupled to the processor and containing instructions that, when executed by the processor, cause the processor to perform operations comprising:
receiving an electronic message that includes a non-command formatted event identifier;
selecting from an event database one or more command formatted instructions associated with the received non-command formatted event identifier; and
causing each of the selected command formatted instructions to be executed on a target device associated with the command formatted instruction.

19. The method of claim 18, wherein the non-command formatted event identifier is an integer number.

20. The method of claim 18, wherein the non-command formatted event identifier is an alphanumeric character.
